(19) United States
(12) Patent Application Publication
(10) Pub. No.: US 2017/0030110 A1
(43) Pub. Date: Feb. 2, 2017

(54) Remote Controlled Bottom Release Gun Storage Shelf System and Method

(71) Applicant: Michael Sahjian, Tyler, TX (US)

(72) Inventor: Michael Sahjian, Tyler, TX (US)

(21) Appl. No.: 14/812,452

(22) Filed: Jul. 29, 2015

(51) Int. Cl. E05B 47/00; E05B 17/10; A47B 83/00; A47B 81/00; E05B 65/46; E05D 7/00

(52) U.S. Cl. CPC E05B 47/0002; E05B 65/46; E05D 7/009; A47B 83/00; A47B 81/00; E05B 17/10; E05B 2047/0072; A47B 2220/0077

(57) ABSTRACT

This disclosure relates to a remote controlled bottom release gun storage shelf system and method. A storage system can comprise a top member, a hinge, a bottom member, a locking system, and a release mechanism. The bottom member can be attached to the top member by the hinge. The top member and the bottom member together can form a chamber capable of storing items. The locking system can connect the top member to the bottom member. The locking system can prevent access to the chamber. The release mechanism can comprise a receiver. The receiver can be capable of receiving a signal from a remote control, wherein upon receiving the signal from the remote control the release mechanism can cause the locking system to disconnect the bottom member from the top member, allowing access to the chamber.

### BACKGROUND

This disclosure relates to a remote controlled bottom release gun storage shelf system and method. Traditionally, weapons such as firearms are placed in a cabinet such as bedside nightstands, and/or desktop cabinets, which can be easily accessible to the owner. However, most burglars are aware of common places wherein weapons may be stashed. In such case, this method cannot prevent weapons from being accessed by other person such as a burglar. Additionally, placing weapons in unlocked cabinets can be dangerous to children and could cause possible accidents and/or harm. Thus, storing weapons in unlocked places can increase risks of accidental injuries or even death to homeowners. Another method of storing firearms is through placing it inside a gun safe storage. In this method, firearms can be placed within a locked storage that are usually accessed through a key, combination, biometric or magnetic lock that requires manual operator input at the site of the device, and can prove time consuming. Such method can be effective in preventing quick access to firearms. However, this method can be ineffective in situations wherein the user needs to access the weapons quickly to be used in self-defense.

As such it would be useful to have an improved remote controlled bottom release gun storage shelf system and method.

### SUMMARY

This disclosure relates to a remote controlled bottom release gun storage shelf system and method. A storage system can comprise a top member, a hinge, a bottom member, a locking system, and a release mechanism. The bottom member can be attached to the top member by the hinge. The top member and the bottom member together can form a chamber capable of storing items. The locking system can connect the top member to the bottom member. The locking system can prevent access to the chamber. The release mechanism can comprise a receiver. The receiver can be capable of receiving a signal from a remote control, wherein upon receiving the signal from the remote control the release mechanism can cause the locking system to disconnect the bottom member from the top member, allowing access to the chamber.

### BRIEF DESCRIPTION OF THE DRAWINGS

FIG. 1 illustrates a storage system.

FIG. 2 illustrates a storage system comprising a top member, and a bottom member.

FIG. 3 illustrates a back view of a storage system.

FIG. 4 illustrates a storage system further comprising a locking system, and a release mechanism.

FIG. 5 illustrates a schematic diagram of a locking system, and a release mechanism 402.

FIG. 6 illustrates a remote control for a storage system.

FIG. 7 illustrates a storage system at a closed position.

FIG. 8 illustrates a storage system at an open position.

FIG. 9 illustrates another embodiment of a storage system.

### DETAILED DESCRIPTION

Described herein is a remote controlled bottom release gun storage shelf system and method. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

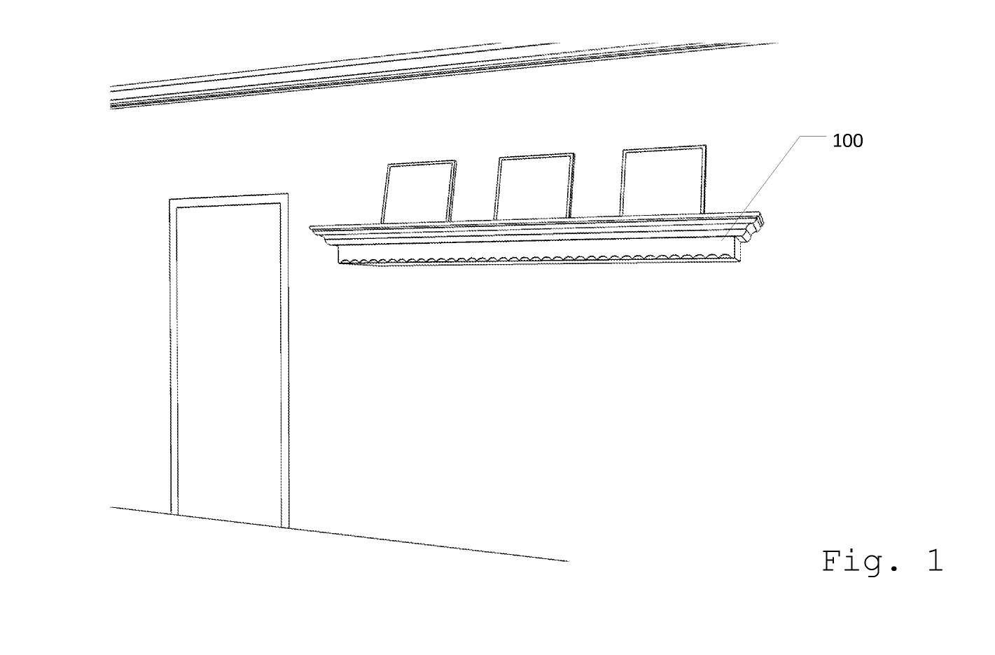

FIG. 1 illustrates a storage system 100. Storage system 100 can provide concealment and secured storage for items such as weapons, and/or firearms. In one embodiment, storage system 100 can be designed as a part of a fixture such as a wall shelf, to hide any indication that storage system 100 hides such items. In another embodiment, storage system 100 can be attachable to various fixtures that can include but is not limited to couches, bench, coffee table, and/or shelving.

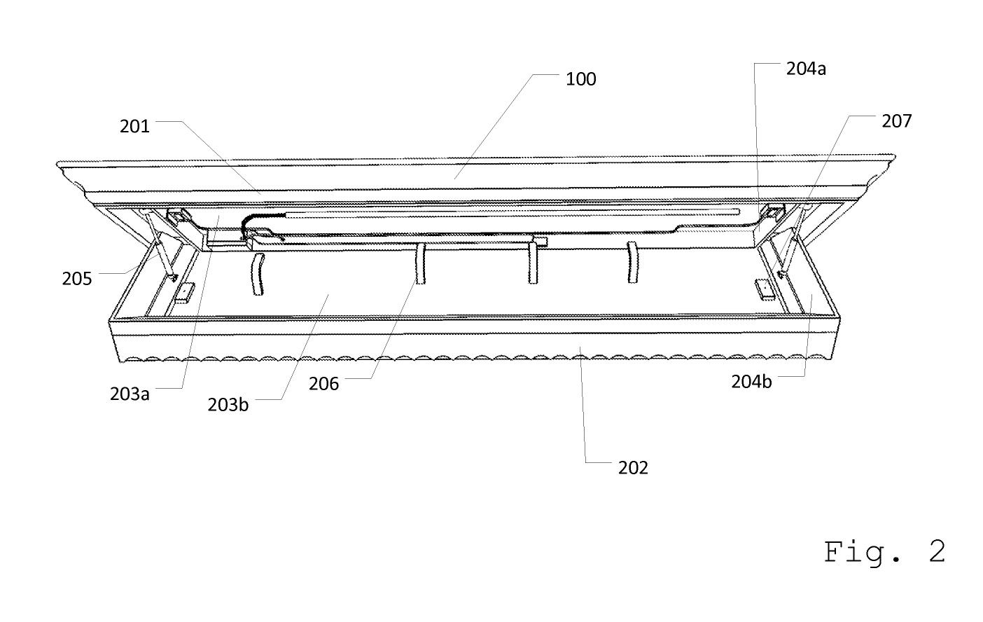

FIG. 2 illustrates storage system 100 comprising a top member 201, and a bottom member 202. Top member 201 and bottom member 202 attached together can form a chamber 203. Top member 201 can be the portion of storage system 100 that permanently attaches to a fixture while bottom member 202 can be the portion that swings open allowing accessibility to chamber 203. Chamber 203 can be capable of storing items such as weapons, and/or firearms. Chamber 203 can comprise a top surface chamber 203a, and a bottom surface chamber 203b. Top surface chamber 203a can be the inner surface of top member 201 while bottom surface chamber 203b can be the inner surface of bottom member 202. Further, top member 201 can connect to bottom member 202 through one or more biasing devices 205. Biasing devices 205 can be capable of moving bottom member 202. In one embodiment, each biasing device 205 can be placed within the opposite sides of chamber 203. First ends of biasing devices 205 can attach within top surface chamber 203a. The other ends of biasing device 205 can attach within bottom surface chamber 203b. In a preferred embodiment, each biasing device 205 can be a gas spring. Bottom surface chamber 203b can further comprise one or more brackets 206, and one or more plates 207. Brackets 206 can secure items such as weapons, and/or firearms within chamber 203 of storage system 100. Brackets 206 can be placed within the middle section of bottom surface chamber 203b. In a preferred embodiment, plates 207 can be placed within the opposite sides of bottom surface chamber 203b. In other embodiments, plates 207 can be within bottom surface chamber 203b. An example of plate 207 is an armature plate.

Top member 201 and bottom member 202 can each comprise a plurality of sidewalls 204. Sidewalls 204 can provide narrow enclosure to chamber 203. A first set of sidewalls 204a can attach to at least three sides of top member 201. A second set of sidewalls 204b can be compatible with first set of sidewalls 204a. Second set of sidewalls 204b can attach to at least three sides of bottom member 202. In one embodiment, when storage system 100 is closed, second set of sidewalls 204b can overlap first set of sidewalls 204a, fully enclosing top member 201. In another embodiment, second set of sidewalls 204b can be mateable with first set of sidewalls 204a. In this embodiment, closing storage system 100 can connect first set of sidewalls 204a with second set of sidewalls 204b.

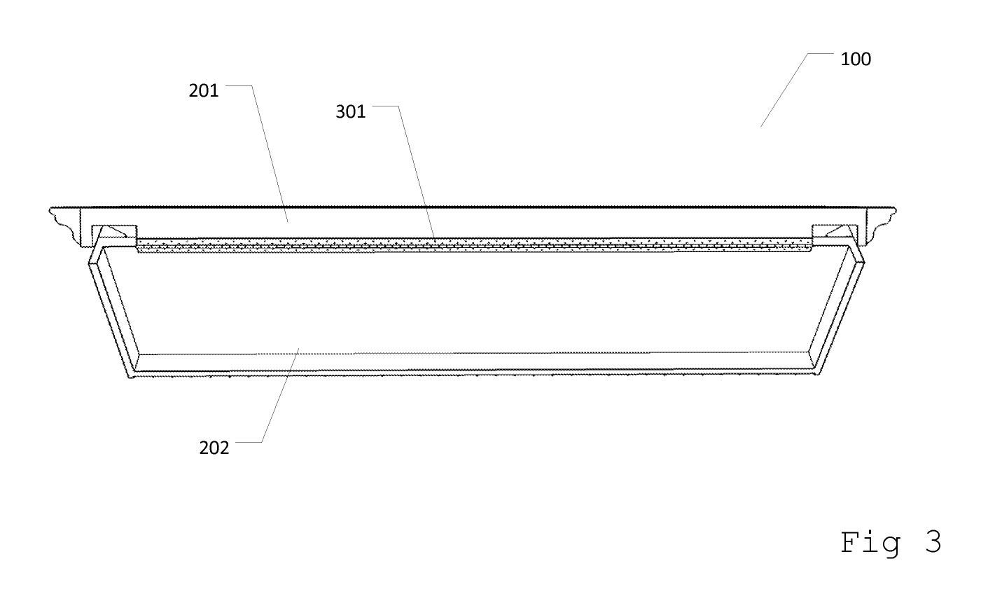

FIG. 3 illustrates a back view of storage system 100. In one embodiment, the back portion of top member 201 can attach to the back portion of bottom member 202 by a hinge 301. Hinge 301 can allow an angle of rotation to bottom member 202, as it swings open. In a preferred embodiment, hinge 301 can be a piano hinge that connects the back portions of top member 201 with bottom member 202.

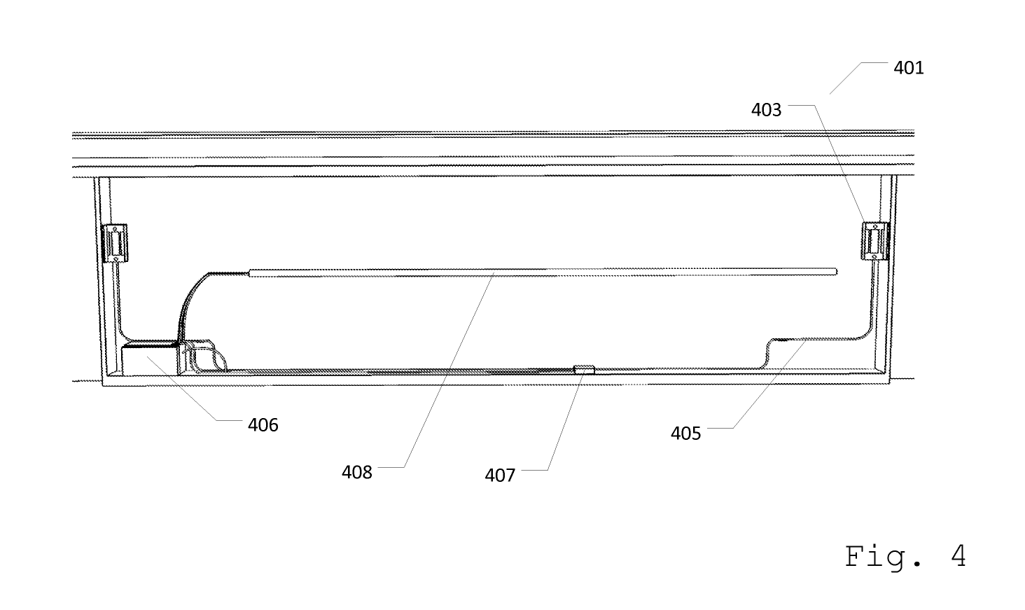

FIG. 4 illustrates storage system 100 further comprising a locking system 401, and a release mechanism 402. Locking system 401 can comprise plates 207, one or more remote controlled magnetic locks 403, and a plurality of wires 405 making for rapid access over other types of locking mechanisms. Magnetic locks 403 can attach within top surface chamber 203a that is opposite to plates 207. In this structure, when storage system 100 is closed, plates 207 can be in contact with each magnetic locks 403. Wires 405 can connect each magnetic lock 403 to a power supply. In one embodiment, locking system 401 can further comprise a battery 406 to maintain lock integrity in the event of a power failure. In such embodiment, each magnetic lock 403 can be connected to battery 406 through wires 405. Battery 406 can attach within top surface chamber 203a.

Further, release mechanism 402 can comprise biasing devices 205 and a receiver 407. Receiver 407 can be capable of receiving a signal from a signal-transmitting device such as a remote control See infra. Receiver 407 can connect to each plate 207 through wires 405. In an embodiment wherein locking system 401 comprises battery 406, receiver 407 can connect to battery 406 through wires 405. Furthermore, receiver 407 can attach within second inner surface of chamber 203. In one embodiment, release mechanism 302 can further comprise one or more LED (light-emitting diodes) lights 408. LED lights 408 can attach within top surface chamber 203a. In this embodiment, LED lights 408 can also be turned on as receiver 307 receives a signal. LED lights 408 can provide illumination to items stored within chamber 203. In one embodiment, battery 406 can supply power to LED lights 408.

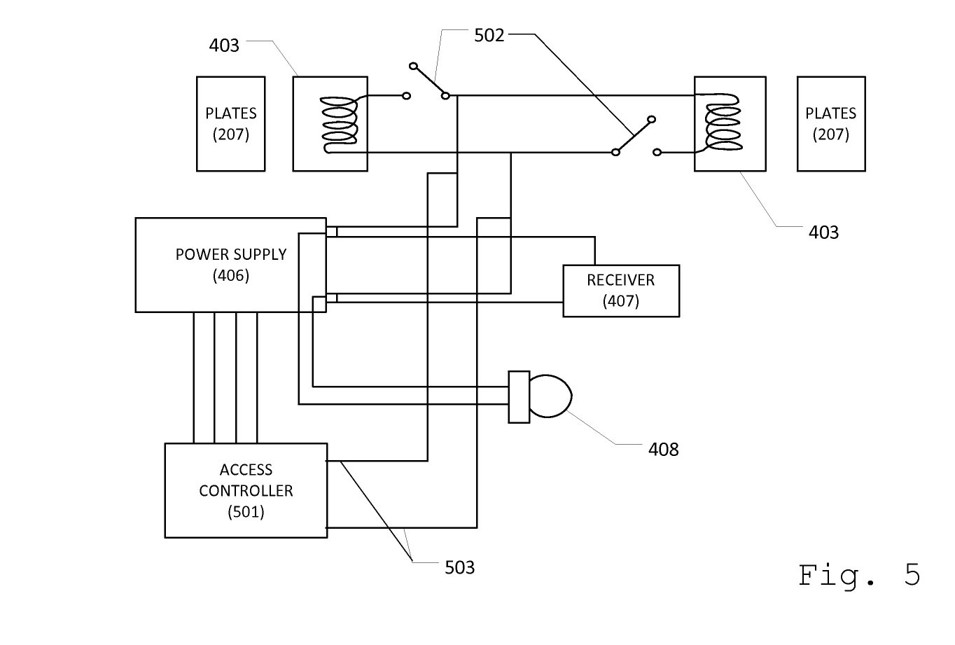

FIG. 5 illustrates a schematic diagram of locking system 401 and release mechanism 402. In one embodiment, locking system 401 and release mechanism 402 can connect directly to a power supply. In another embodiment, locking system 401 and release mechanism 402 can connect to battery 406. In one embodiment, battery 406 can be rechargeable. Battery 406 can be capable of supplying power to magnetic locks 403, receiver 407, led light 408, and an access controller 501. Receiver 407 can be capable of receiving a signal from a signal-transmitting device such as a remote control See infra. Receiver 407 can be a transmitter and receiver, in one embodiment. Further in one embodiment, storage system 100 can further comprise access controller 501, and one or more switches 502 connected through control lines 503. In one embodiment, access controller 501 can consist essentially of a plurality of relays. In another embodiment, access controller 501 can be a microcontroller. At a signal received from receiver 407, access controller 501 can transmit signal to actuate switches 502 to turn on and/or turn off. When the signal received is to turn on switches 502, electric current from battery 406 can pass through wires 405 producing magnetic field on magnetic locks 403. The magnetic field on magnetic locks 403 can attract plates 207. The force between magnetic locks 403 and plates 207 secures both objects together. Further when the signal received form receiver 407 is to turn off switches 502, access controller 501 can turn off switches 502 that can prevent electric current from battery 406 to pass through wires 405. This can then release plates 207 from magnetic locks 403.

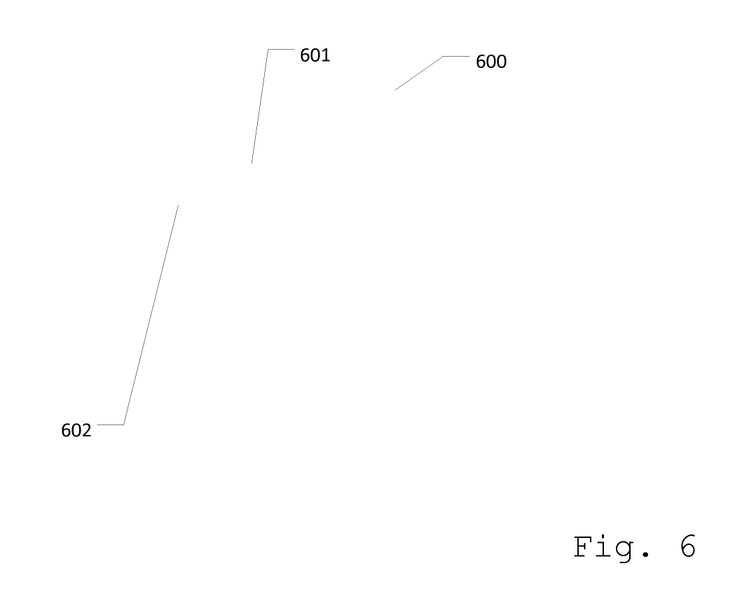

FIG. 6 illustrates a remote control 600 for storage system 100. In one embodiment, pressing a button 601 of remote control 600 can allow a signal to be transmitted. The signal transmitted from remote control 600 can comprise an unlock request that tells storage system 100 to open and/or lock. In one embodiment, remote control 600 can comprise an access control system 602 that collects access control data to identify an authorized user. In one embodiment, access control system 602 can comprise a biometric reader such as a fingerprint reader. Fingerprint reader can be a portion of button 601, such that when a user pushes button 601, remote control can collect access control data from a user to be compared against pre-collected control data collected from the user. In one embodiment, remote control 600 can compare access control data 602 to pre-collected control data, and if there is a match, send an unlock request to storage system 100. In another embodiment, remote control 600 can transmit access control data to storage system 100. In such embodiment, storage system 100 can compare access control data to pre-collected control data, and if there is a match, unlock storage system 100.

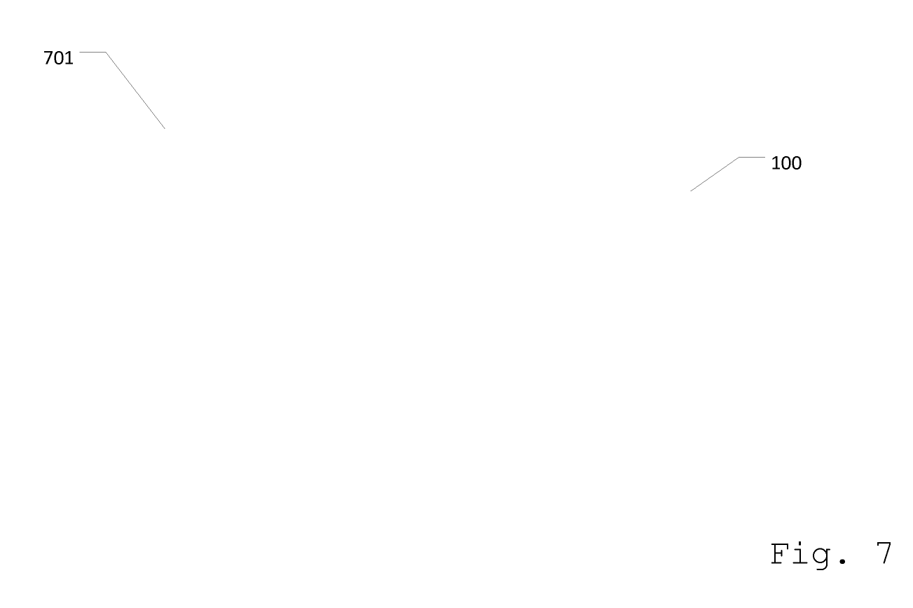

FIG. 7 illustrates storage system 100 at a closed position 701. In a closed position, locking system 401 can prevent access to chamber 203 by connecting bottom member 202 with top member 201. In such position, electric current that passes through wires 405 can power magnetic locks 403. The current can create a magnetic flux that attracts plates 207 to magnetic locks 403 thus, keeping bottom member 202 connected with top member 201. Further in a scenario wherein there is a power disruption, battery 406 can provide energy to magnetic locks 403 to retain storage system 100 in a closed position. In another embodiment, a powered backup locking system such as mechanically actuatable hook can be held open in a powered state and biased in a closed, fail-safe position in the event of complete power failure.

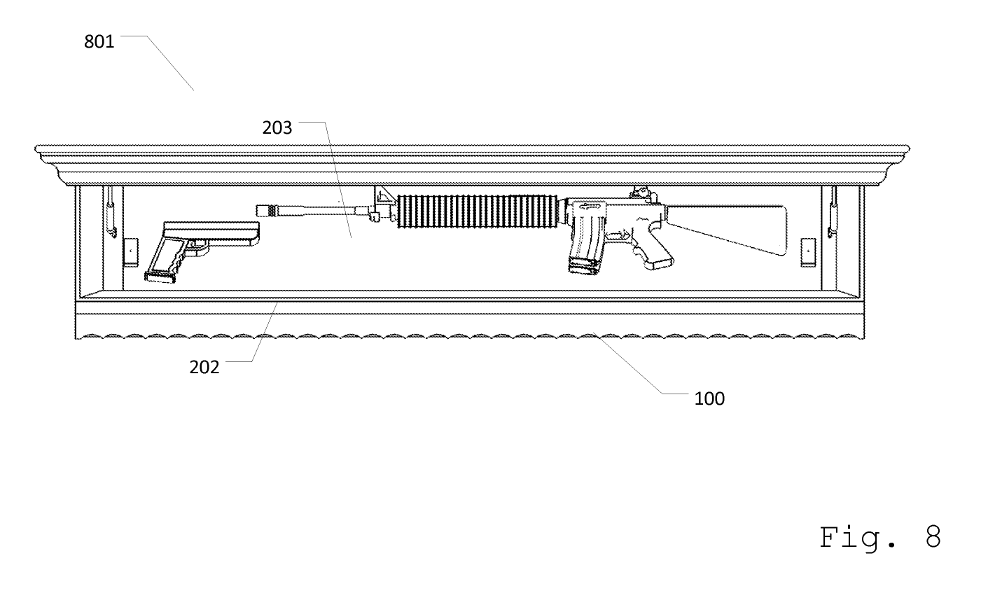

FIG. 8 illustrates storage system 100 at an open position 801. To allow access of chamber 203, remote control 600 can be actuated to transmit a signal. Receiver 407 can receive the signal transmitted by remote control 600. Upon receiving the signal, release mechanism 402 can cause locking system 401 to disconnect bottom member 202 from top member 201. Release mechanism 402 can be capable of cutting power supply to magnetic locks 403, which can allow bottom member 202 to be released from top member 201. Biasing device 205 can allow release of bottom member 202 at a regulated phase. This can ensure that items are kept in place within chamber 203 and do not fall from bottom member 202, as storage system 100 is opened. Furthermore, remote control 600 can allow quick operation of storage system 100 and allows immediate access to items within chamber 203.

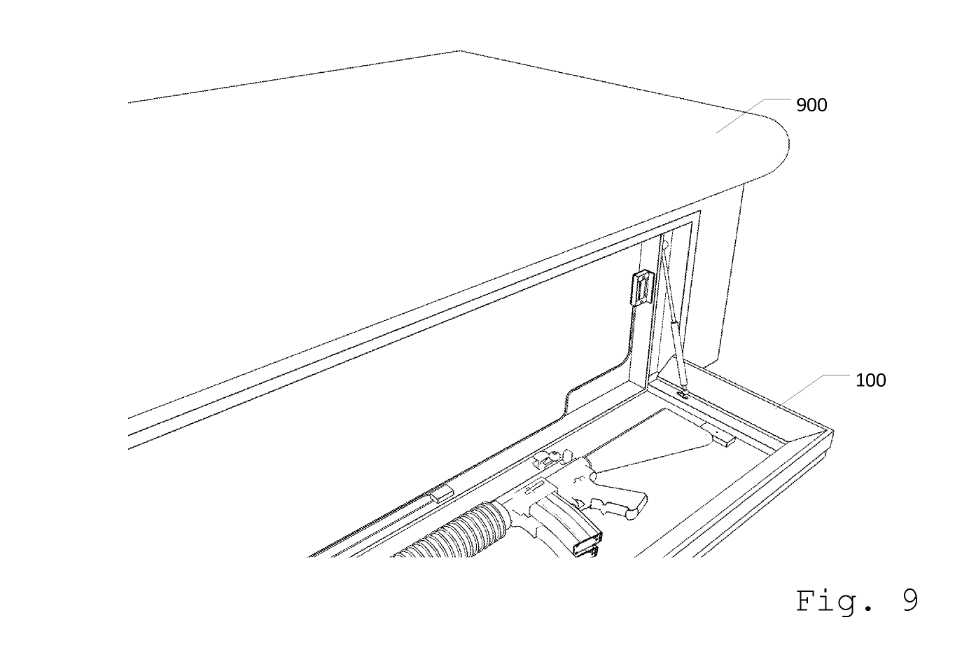

FIG. 9 illustrates another embodiment of storage system 100. In this embodiment, storage system 100 can be attached to a couch 900. Such embodiment can be advantageous to users who spend most of the time in couch 900. In such embodiment, top member 201 can be attached to front panel of couch 900 to allow quick access to items such as weapons and/or firearms.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A storage system comprising
a top member;
a hinge;
a bottom member attached to said top member by said hinge, said top member and said bottom member together forming a chamber capable of storing items;
a locking system that connects said top member to said bottom member, further wherein said locking system prevents access to said chamber; and
a release mechanism comprising a receiver, said receiver capable of receiving a signal from a remote control, wherein upon receiving said signal from said remote control said release mechanism causes said locking system to disconnect said bottom member from said top member, allowing access to said chamber.

2. The storage system of claim 1, wherein said locking system comprises one or more magnetic locks.

3. The storage system of claim 2, wherein said locking system further comprises a battery, said magnetic locks connected to said battery through one or more wires.

4. The storage system of claim 1, wherein said release mechanism comprises a biasing device, said biasing device capable of pushing said bottom member into an open position when said locking system disconnects.

5. The storage system of claim 1 wherein said hinge is a piano hinge.

6. The storage system of claim 3, wherein said biasing device is a gas spring.

7. The storage system of claim 1, wherein said release mechanism further comprising one or more LED (light-emitting diodes) lights.

8. The storage system of claim 1, wherein said storage system is a shelf.

9. The storage system of claim 1, wherein said storage system is attached to a couch.

10. A method for controlling access to a storage system comprising the steps of
preventing access to a chamber of said storage system through a locking system, said locking system connects a top member to a bottom member, said bottom member attached to said top member by said hinge, said top member and said bottom member together forming said chamber capable of storing items; and
allowing access to said chamber through a release mechanism, said release mechanism comprising a receiver, said receiver capable of receiving signal from a remote control, wherein upon receiving said signal from said remote control said release mechanism causes said locking system to disconnect said bottom member from said top member.

11. The method of claim 8 further comprising the step of actuating said remote control to allow access to said chamber.

12. The method of claim 8 wherein after said chamber is accessed comprising the step of moving said bottom member to connect said bottom member with said top member.

13. The method of claim 8 wherein upon receiving said signal from said remote control comprising the step of illuminating said chamber using one or more LED (light-emitting diodes) lights.

14. The method of claim 8, wherein said locking system comprises one or more magnetic locks.

15. The method of claim 9, wherein said locking system further comprises a battery, said magnetic locks connected to said battery through one or more wires.

16. The method of claim 8, wherein said release mechanism comprises a biasing device, said biasing device capable of pushing said bottom member into an open position when said locking system disconnects.

17. The method of claim 14, wherein said biasing device is a gas spring.

18. The method of claim 8, wherein said hinge is a piano hinge.
